(19) United States
(12) Patent Application Publication
(10) Pub. No.: US 2023/0288791 A1
(43) Pub. Date: Sep. 14, 2023

(54) LIGHT SOURCE DEVICE AND DISPLAY APPARATUS

(71) Applicants: Yohei TAKANO, Kanagawa (JP); Makoto HIRAKAWA, Tokyo (JP); Takashi SASAKI, Kanagawa (JP); Kasumi NAKAMURA, Kanagawa (JP); Kazuhiro FUJITA, Tokyo (JP)

(72) Inventors: Yohei TAKANO, Kanagawa (JP); Makoto HIRAKAWA, Tokyo (JP); Takashi SASAKI, Kanagawa (JP); Kasumi NAKAMURA, Kanagawa (JP); Kazuhiro FUJITA, Tokyo (JP)

(21) Appl. No.: 18/114,989

(22) Filed: Feb. 28, 2023

(30) Foreign Application Priority Data
Mar. 9, 2022 (JP) 2022-036526

(51) Int. Cl. G03B 21/20

(52) U.S. Cl. CPC G03B 21/204; G03B 21/208; G03B 21/2066

(57) ABSTRACT

A light source device includes: a light source to emit light including first color light of excitation light; an optical element including multiple lenses on at least one surface of the optical element; a condenser optical system to condense the first color light; a wavelength converter to convert the first color light into second color light; and a color light separator to separate the first color light and the second color light. The light source, the optical element, the condenser optical system, the wavelength converter, and the color light separator are disposed in this order from the light source. The multiple lenses of the optical element has: a first divergence angle in a first direction along a plane of the multiple lenses; and a second divergence angle in a second direction orthogonal to the first direction, and the first divergence angle is smaller than a second divergence angle.

### CROSS-REFERENCE TO RELATED APPLICATIONS

This patent application is based on and claims priority pursuant to 35 U.S.C. § 119(a) to Japanese Patent Application No. 2022-036526, filed on Mar. 9, 2022, in the Japan Patent Office, the entire disclosure of which is hereby incorporated by reference herein.

### BACKGROUND

### Technical Field

The present disclosure relates to a light source device and a display apparatus.

### Related Art

In recent years, a projection display apparatus, a display apparatus, or a projector increases the efficiency and reduces the size. When the higher efficiency is achieved, the number of light sources used in the projector is reduced, and heat generation or power consumption is reduced. Thus, the size of the power supply or the cooling device in the projector is also reduced. As a result, the entire size of the projector is reduced.

For example, excitation light emitted from the light source is reflected by the dichroic mirror to irradiate a wavelength converter with the reflected light, and a fly-eye lens is used to increase the light conversion efficiency in the projector.

### SUMMARY

A light source device includes: a light source to emit light including first color light of excitation light; an optical element including multiple lenses on at least one surface of the optical element; a condenser optical system to condense the first color light; a wavelength converter to convert the first color light into second color light; and a color light separator to separate the first color light and the second color light. The light source, the optical element, the condenser optical system, the wavelength converter, and the color light separator are disposed in this order from the light source. The multiple lenses of the optical element has: a first divergence angle in a first direction along a plane of the multiple lenses; and a second divergence angle in a second direction orthogonal to the first direction along the plane, and the first divergence angle is smaller than a second divergence angle.

Further, an embodiment of the present disclosure provides a display apparatus including: the light source device described above; a light homogenizer to homogenize light emitted from the light source device; an illumination optical system to illuminate an image formation element with the light homogenized by the light homogenizer to generate an image; and a projection optical system to magnify and project the image formed by the image formation element outside the display apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram of a projection display apparatus according to a first embodiment:

FIG. 2 is a diagram of a light source device according to the first embodiment;

FIG. 3A is a diagram of a configuration of a phosphor wheel in a plan view according to the first embodiment:

FIG. 3B is a cross-sectional view of the phosphor wheel in FIG. 3A in according to the first embodiment;

FIG. 4A is a diagram of a configuration of an optical element in a plan view according to the first embodiment;

FIG. 4B is a cross-sectional view of the optical element in FIG. 4A according to the first embodiment;

FIG. 5A is a diagram of the diverging light of the excitation light after passing through the optical element in one direction;

FIG. 5B is a diagram of the diverging light of the excitation light after passing through the optical element in another direction;

FIG. 6 is a diagram of divergence angles of the light corresponding to different aperture diameters of a spherical lens;

FIG. 7 is a diagram of an optical path of the excitation light in the light source device according to the first embodiment;

FIG. 8 is a diagram of an optical path of the excitation light in a light source device according to a comparative example;

FIG. 9A is a diagram of an image formed on the phosphor wheel according to the first embodiment:

FIG. 9B is a graph of the luminance distributions of the image in FIG. 9A according to the first embodiment:

FIG. 10 is a diagram of a configuration of a color wheel according to the first embodiment;

FIG. 11 is a diagram of a configuration of a light source device according to a second embodiment;

FIG. 12 is a plan view of a dichroic mirror as viewed from a light incident direction.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an.” and “the” are intended to include the plural forms as well, unless the context clearly indicates otherwise.

According to the embodiments of the present invention, in the display apparatus (the projection display apparatus, the projector), the light source device increases the efficiency, and the size of the light source device is reduced.

Hereinafter, an embodiment will be described with reference to the drawings. In order to facilitate understanding of the description, the same reference numerals are assigned to the same constituent elements as much as possible in each of the drawings, and duplicate description is omitted.

In the following description, the X-direction, the Y-direction, and the Z-direction are perpendicular to each other. Herein, the Y-direction and the Z-direction are the horizontal directions, and the X-direction the is the vertical direction. The Y-direction is the direction along the optical axis of the fluorescent light L2 (i.e., the second color light) that is converted by the phosphor wheel 27 (the fluorescent wheel) and reaches the light homogenizer 13. The Y-direction is also the direction of an arrangement of the second optical system 26. The Z-direction is the direction along the optical axis of the excitation light L1 (i.e., the first color light) emitted from the laser light source 21. The Z-direction is also the direction of an arrangement of the first optical system 23.

Herein, the “display apparatus” according to the present embodiment (e.g., the display apparatus 11) is a kind of display apparatus. Specifically, the display apparatus 11 is a projection display apparatus to project and display an image or video onto a large screen. In the display apparatus 11, the image is enlarged and projected onto the screen by using digital light processing (DLP®) or the liquid crystal display. The “display apparatus” may be referred to as a projector, a projection display apparatus or a projection apparatus.

Display Apparatus

Recently, the projectors for enlarging and projecting various images are widely spread. In the projectors, light emitted form a light source is condensed on a spatial light modulator or an image display such as a digital micromirror device (DMD) or a liquid crystal display, and the light condensed on the spatial light modulator is modulated according to an image signal to generate modulated light, and the modulated light is displayed onto a screen as a color image.

In the projectors, for example, an ultra-high pressure mercury lamp having high brightness has been used as a light source. However, since life of such a lamp is shorter, the lamp is frequently maintained. In recent years, the number of projectors using a laser or a light emitting diode (LED), instead of the ultra-high pressure mercury lamp is growing. Such projectors using a laser or an LED as a light source have a longer life and higher color reproducibility due to its monochromaticity than the ultra-high mercury lamp.

In the projector, an image is formed by irradiating an image display element such as the DMD with three colors of red, green and blue. Although all three colors can be generated by a laser light source, the luminous efficiency of a green laser or a red laser is lower than that of a blue laser. Thus, a method using a fluorescence (e.g., phosphor) and a blue laser as excitation light is a typical method. In the method, the blue light emitted from the blue laser is emitted to the phosphor to generate fluorescent light, in which the wavelength of the blue light is converted, and green light or red light is extracted the fluorescent light.

In recent years, the projector increases the efficiency and reduces the size. When the higher efficiency is achieved, the number of light sources used in the projector is decreased, and heat generation or power consumption is reduced. The size of the power supply or the cooling device in the projector is also reduced. As a result, the entire size of the projector is reduced. In order to increase the efficiency of the light source optical system, the luminous efficiency of the wavelength converter is increased. The conversion efficiency of the wavelength converter is varied with energy density of the excitation light striking the phosphor of the wavelength converter. If the energy density of the light striking the phosphor is higher, the conversion efficiency decreases because of an increase in temperature of the phosphor or a decrease in the number of excitable electrons in a layer of the phosphor. Thus, the conversion efficiency of the phosphor is increased by reducing the energy density as much as possible and increasing the spot size of the excitation light on the phosphor.

In order to increase the conversion efficiency, a spot of the excitation light on the wavelength converter is uniformed. Specifically, a technique using a diffuser, a diffusing plate, or a fly-eye lens is used as a typical method.

### First Embodiment

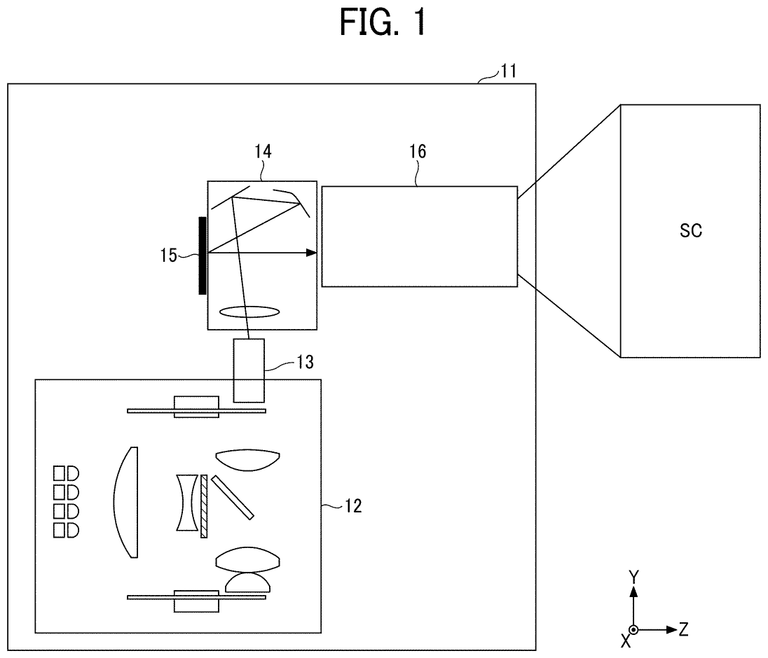

FIG. 1 is a diagram of the display apparatus 11 according to a first embodiment. As illustrated in FIG. 1, in the display apparatus 11, the light emitted from the light source device 12 is homogenized (mixed) by the light homogenizer 13 to homogenize (mix) the light (i.e., intensity or luminance distribution of the light), the homogenized light is illuminated substantially uniformly on the image formation element 15 using the illumination optical system 14, and the image formed by the image formation element 15 is enlarged and projected onto the screen SC by the projection optical system 16. In FIG. 1, the display apparatus 11 includes a configuration using the DMD as an example, but the configuration of the display apparatus 11 is not limited thereto.

The specific configuration of the light source device 12 will be described later in detail. As the light homogenizer 13, for example, a light tunnel in which four mirrors are combined, a rod integrator, or a fly-eye lens is used. The image formation element 15 is a light valve or a spatial light modulator such as a digital micromirror device (DMD), a transmissive liquid crystal panel, or a reflective liquid crystal panel. The display apparatus 11 includes the illumination optical system 14 and the projection optical system 16.

A display apparatus includes: the light source device according to the embodiment described above; a light homogenizer to homogenize light emitted from the light source device; an illumination optical system to illuminate an image formation element to form an image with the light homogenized by the light homogenizer; and a projection optical system to magnify and project the image formed by the image formation element to outside.

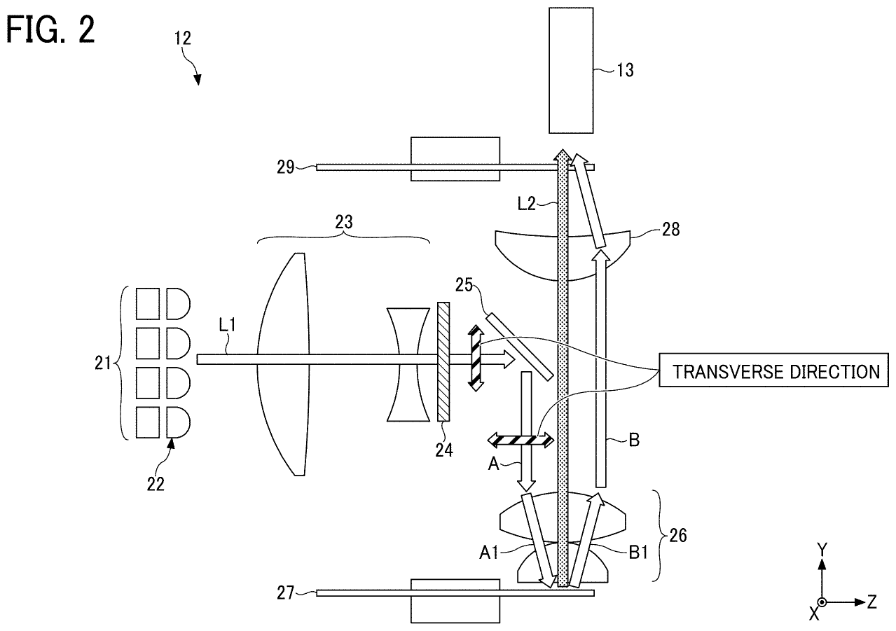

FIG. 2 is a diagram of a light source device 12 according to the first embodiment. The light source device 12 includes a laser light source 21 of a solid light source, a collimator lens 22 corresponding to each light source, a first optical system 23, an optical element 24 (a lens array) in which multiple spherical lenses 39 are arranged in an array on one or both surfaces, a dichroic mirror 25 (a color separation element, a color light separator), a second optical system 26 (a condenser optical system), a phosphor wheel 27 (wavelength converter), a condenser lens 28, and a color wheel 29. The laser light source 21, the collimator lens 22, the first optical system 23, the optical element 24, the dichroic mirror 25, the second optical system 26, the phosphor wheel 27, the condenser lens 28, and the color wheel 29 are arranged in this order along the propagation path of the excitation light emitted from the laser light source 21.

For example, the laser light source 21 emits excitation light L1 (i.e., the first color light) in a blue band having a center wavelength of emission intensity of 455 nm. The light L1 is the excitation light for exciting the phosphor 37 provided with a phosphor wheel 27 described later. The excitation light L1 (i.e., the blue laser light) emitted from the laser light source 21 is linearly polarized light having a constant polarization state, and is to be the S-polarized light with respect to the dichroic mirror 25.

Herein, the S-polarized light reaches the dichroic mirror 25, but the polarized light is not limited thereto. The P-polarized light or the light having other polarized states may be used. The wavelength band of the light is not limited to the blue band as long as the light has a wavelength that excites the phosphor 37 described later. In the embodiment, the laser light source 21 includes multiple laser light sources, but is not limited thereto. The laser light source 21 may be a single laser light source. As the multiple laser light sources, light source units arranged in an array on the substrate may be used, but are not limited thereto.

In the present embodiment, the center line of a light beam formed by the excitation light L1 emitted from single or multiple laser light sources 21 is referred to as a “principal ray”. In FIG. 2, the principal ray is represented by outline arrows A, B, A1, and B1. In addition, the center line of the light beam formed by the fluorescent light L2 converted by the phosphor wheel 27 in wavelength is also referred to as a “principal ray”. In FIG. 2, the principal ray is represented by the gray arrow.

The excitation light L1 emitted from the multiple laser light sources 21 becomes substantially parallel light by the collimator lens 22 corresponding to each laser light source 21. The excitation light L1 that is substantially parallel light enters the first optical system 23. The optical axis of the first optical system 23 is disposed so as to pass through the center of the light source array of the laser light source 21. The principal ray of the excitation light L1 coincides with the optical axis of the first optical system 23.

The excitation light L1 after passing through the first optical system 23 passes through the optical element 24 and is guided to the dichroic mirror 25 disposed at an angle of 45 degrees with respect to the optical axis of the first optical system 23. In the present embodiment, the angle is 45 degrees in the arrangement, but it is not limited to 45 degrees. Another angle may be used in the configuration. The dichroic mirror 25 is coated so as to reflect the light having the wavelength band of the excitation light L1 and to transmit the fluorescent light L2, which is represented by the dark arrow A in FIG. 2, generated from the phosphor 37 (a fluorescent substance) described later. The shape of the dichroic mirror 25 used in the present embodiment is a flat plate, but is not limited thereto. A prism dichroic mirror may be used. The excitation light L1 reflected by the dichroic mirror 25 is bent in its optical path by 90 degrees, which is the principal ray A as illustrated in FIG. 2, and enters the second optical system 26 (i.e., the condenser optical system).

The excitation light L1 is folded by the dichroic mirror 25 after passing through the optical element 24 (i.e., the transmitted light). When a plane including the incident light to and the reflection light from the dichroic mirror 25 is defined, in which the plane corresponds to the YZ-plane, the spread angle (i.e., divergence angle) of the transmitted light on the YZ-plane (i.e., the Y-direction, the first direction) is smaller than the spread angle (i.e., divergence angle) of the transmitted light on the ZX-plane (i.e., the X-direction, the second direction).

A light source device includes: a light source to emit light including first color light of excitation light; an optical element including multiple lenses arranged on at least one surface of a light source side; a condenser optical system to condense the first color light; a wavelength converter to convert the first color light into second color light; and a color light separator to separate the first color light and the second color light. The multiple lenses of the optical element has a first divergence angle in a first direction along a plane of the multiple lenses, the first divergence angle is smaller than a second divergence angle in a second direction perpendicular to the first direction.

A light source device includes: a light source to emit light including first color light of excitation light; an optical element including multiple lenses on at least one surface of the optical element; a condenser optical system to condense the first color light; a wavelength converter to convert the first color light into second color light; and a color light separator to separate the first color light and the second color light. The light source, the optical element, the condenser optical system, the wavelength converter, and the color light separator are disposed in this order from the light source. The multiple lenses of the optical element has: a first divergence angle in a first direction along a plane of the multiple lenses; and a second divergence angle in a second direction orthogonal to the first direction along the plane, and the first divergence angle is smaller than a second divergence angle.

Herein, the optical axes of the first optical system 23 and the second optical system 26 (i.e., condenser optical system) are substantially off-axial. The excitation light L1 after passing through the second optical system 26 is guided to the phosphor wheel 27. Since the excitation light L1 off-axially enters the second optical system 26 (the condenser optical system), the excitation light L1 obliquely strikes the phosphor wheel 27. In the vicinity of the phosphor wheel 27, the excitation light L1 is represented as the principal ray A1 (FIG. 2). The principal ray A1 obliquely strikes the phosphor wheel 27 relative to the negative Y-direction and the positive Z-direction.

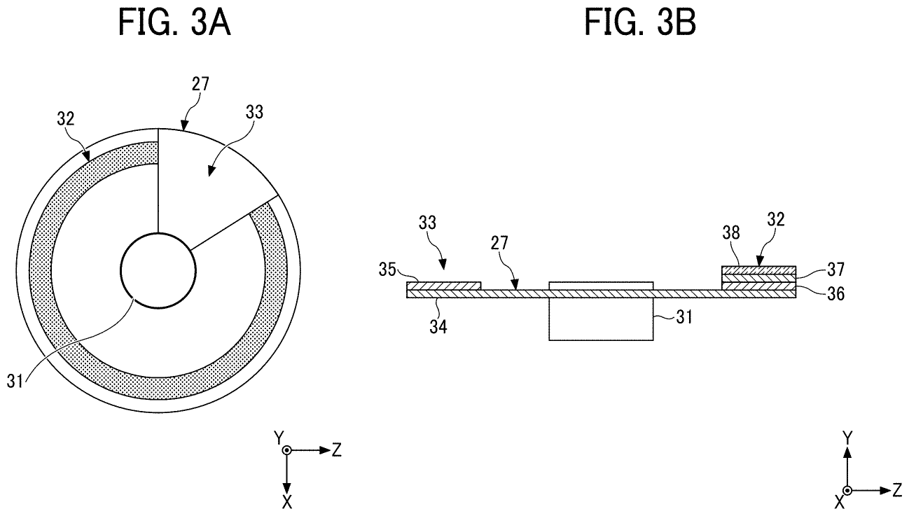

FIGS. 3A and 3B are diagrams of the configuration of the phosphor wheel 27 according to the first embodiment. FIG. 3A is a plan view as viewed from the positive Y-direction, and FIG. 3B is a cross-sectional view as viewed from the positive the X-direction.

As illustrated in FIG. 3, the phosphor wheel 27 having a flat circular shape is attached to the drive motor 31 and rotates at a higher speed to move a position irradiated with the excitation light L1 in a time division manner. In the present embodiment, the phosphor wheel 27 is divided into a phosphor region 32 coated with the phosphor 37 and an excitation light reflection region 33 to reflect the excitation light. In FIG. 3, the phosphor wheel 27 is divided into two regions as an example. The phosphor regions 32 may be divided into two or more multiple regions, and multiple excitation light reflection regions 33 may be provided.

As illustrated in FIG. 3B, a transparent substrate or a metal substrate such as aluminum is used as the substrate 34 of the phosphor wheel 27, but the substrate 34 is not limited thereto. In the excitation light reflection region 33, for example, the reflection coat 35 having a higher reflectivity with respect to the excitation light L1 may be formed on the substrate 34, or the metal substrate may be used as the reflection region as described above.

In FIG. 3B, as a laminated structure of the phosphor region 32, a reflection coat 36 to reflect the light having the wavelength band of the fluorescent light L2 emitted from the layer of the phosphor 37, the phosphor 37, and antireflection (AR) coat to reduce the reflection on the surface of the phosphor 37 are laminated. The laminated structure is not limited thereto, and other structures may be used. In a case where the metal substrate uses as the substrate 34, the reflective coating 36 is omitted. A layer of the phosphor 37 may be formed by dispersing a phosphor material in an organic or inorganic binder or by directly forming a crystal of the phosphor material. As a phosphor material, rare earth phosphors such as Ce doped yttrium aluminum garnet (Ce: YAG) materials or YAG based phosphors are used, but the phosphor materials are not limited thereto. A phosphorescent material or a nonlinear optical crystal may be used. The wavelength band of the fluorescent light L2 emitted from the phosphor 37 may be in the wavelength band of, for example, yellow, blue, green, or red. Herein, the case where the fluorescent light L2 having the wavelength band of yellow is used will be described.

The range of color reproducibility expands, and the display apparatus 11 reproduces a wide variety of color in images by using multiple wavelength converters in the phosphor wheel 27.

In FIG. 2, the excitation light L1 striking the excitation light reflection region 33 of the phosphor wheel 27 in which the phosphor 37 is not formed obliquely reflects off the excitation light reflection region 33 to enter the second optical system 26 (condenser optical system). In FIG. 2, in the vicinity of the phosphor wheel 27, the reflected light is represented as the principal ray B1. On the reflection surface of the reflection coat 35 (FIG. 3B), the principal ray B1 is reflected obliquely to the positive Y-direction and the positive Z-direction. The relation between the principal ray A1 and the principal ray B1 with respect to the reflection surface is the specular reflection. The second optical system 26 changes the direction of the principal ray B1 obliquely reflected from the reflection surface of the phosphor wheel 27 to the positive Y-direction. The principal ray after passing through the second optical system is represented as the principal ray B in FIG. 2. The principal ray B enters the condenser lens 28 while avoiding the dichroic mirror 25 (without striking the color light separator), and reaches the light homogenizer 13 after passing through the color wheel 29. Herein, the principal ray A of the excitation light L1, the principal ray A1 of the excitation light L1 incident on the phosphor wheel 27, the principal ray B1 of the excitation light L1 reflected from the phosphor wheel 27, and the principal ray B of the excitation light L1 are parallel to the YZ-plane in FIG. 2.

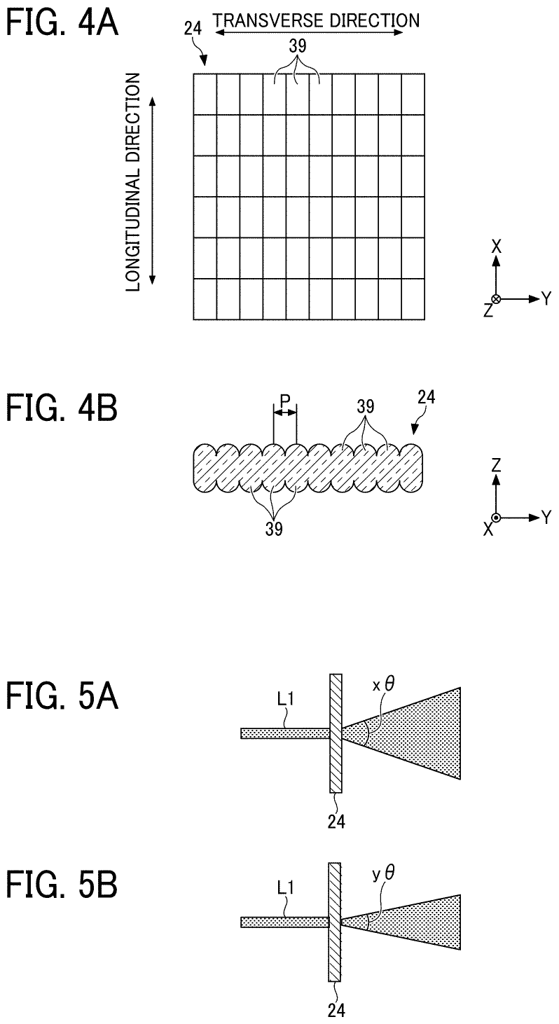

FIGS. 4A and 4B are the diagrams of the configuration of the optical element 24 used in the first embodiment. FIG. 4A is a plan view as viewed from the light incident side (i.e., from the negative Z-direction) of the excitation light L1. FIG. 4B is a cross-sectional view as viewed from the X-direction orthogonal to the light incident direction. In FIG. 4B, the excitation light L1 enters the optical element 24 from the negative Z-direction (the upper side in the drawing).

As illustrated in FIG. 4A, the optical element 24 includes multiple spherical lenses 39. Each spherical lens 39 has a rectangular shape (i.e., the outer shape), and the multiple spherical lenses 39 are arrayed in the XY-plane (i.e., the lens array). As illustrated in FIG. 4B, each spherical lens 39 is a spherical lens. The spherical lens 39 is a biconvex lens and has curved surfaces on both side of the optical element 24. The spherical lens 39 is not limited to the biconvex lens, and may be a plano-convex lens. Herein, the front side is the negative Z-direction, and the rear side is positive Z-direction. The focal length of the lens array of the optical element 24 and the focal length of the second optical system 26 are appropriately set so that the image having a similar shape of the spherical lens 39 is formed on the phosphor wheel 27

As illustrated in FIG. 4B, the distance between the vertex of one spherical lens 39 and the vertex of another spherical lens 39 adjacent to the one lens is referred to as a lens interval P. In the present embodiment, as illustrated in FIG. 4A, each spherical lens 39 of the optical element 24 has a rectangular shape as viewed from the Z-direction. Since the outer shape is rectangular, the lens interval P is different between the X-direction (i.e., second direction) and the Y-direction (i.e., the first direction). The lens interval in the X-direction is referred to as a lens interval Px, and the lens interval in the Y-direction is referred to as a lens interval Py. In the present embodiment, the X-direction is the longitudinal direction of the spherical lens 39, and the Y-direction is the transverse direction of the spherical lens 39. Herein, the entrance shape of the light homogenizer 13 or the image forming surface of the image formation element 15 has a rectangular shape. Since the rectangular shape of the spherical lens 39 and the entrance shape of the light homogenizer 13 or the image forming surface of the image formation element 15 are similar, the light is less likely to cut by the illumination optical system 14 or the projection optical system 16.

In the present embodiment, the outer shape of the spherical lens 39 is the rectangular shape, but is not limited thereto. The outer shape of the spherical lens 39 may be other shapes such as a triangular shape and a hexagonal shape. In such a case, the longitudinal direction is defined as the X-direction and the transverse direction is defined as the Y-direction. The longitudinal direction of the lens array of the optical element 24 is parallel to the plane (i.e., the YZ-plane) orthogonal to the principal ray A and the principal ray B. In the present embodiment, the longitudinal direction of the spherical lens 39 is parallel to the YZ-plane, but the longitudinal direction of the spherical lens 39 may be between 0 and 45 degrees with respect to the YZ-plane.

In the light source device according to the embodiments, a longitudinal direction of the multiple lenses of the optical element is orthogonal to a plane parallel to the first principal ray and the second principal ray.

In the present embodiment, as illustrated in FIG. 4B, the multiple spherical lenses 39 are arrayed (i.e., lens array) on both sides (i.e., the front side and the rear side) of the optical element 24. Herein, the front side is the negative Z-direction and the rear side is the positive Z-direction. The lens array (i.e., the multiple spherical lenses 38) may be arranged on at least the front side.

FIGS. 5A and 5B are diagrams of the diverging light of the excitation light L1 after passing through the optical element 24. FIG. 5A is a side view of the optical element 24 as viewed from the longitudinal side (i.e., the Y-direction) of each spherical lens 39, and FIG. 5B is a side view of the optical element 24 as viewed from the transverse side (i.e., the X-direction) of each spherical lens 39. The vertical direction of the optical element 24 illustrated in FIG. 5A corresponds to the longitudinal direction of each spherical lens 39, and the vertical direction of the optical element 24 illustrated in FIG. 5B corresponds to the transverse direction of each spherical lens 39. In FIGS. 5A and 5B, the divergence angles are exaggerated in the drawings.

The divergence angle yθ of the excitation light L1 after passing through the optical element 24 in the transverse direction (i.e., the Y-direction, first direction) in FIG. 5B is smaller than the divergence angle xθ of the excitation light L1 after passing through the optical element 24 in the longitudinal direction (i.e., the X-direction, second direction) in FIG. 5A. As described above, since each spherical lens 39 of the lens array of the optical element 24 has a rectangular shape, and the multiple spherical lenses 39 are arrayed in two dimensions, the divergence angle in the transverse direction is smaller than that in the longitudinal direction. Such a configuration is more preferable.

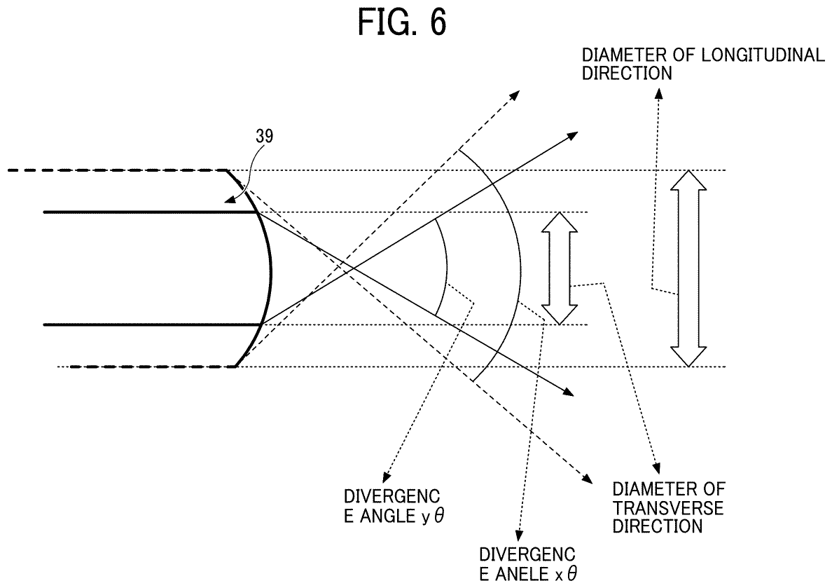

FIG. 6 is a diagram of divergence angles corresponding to difference aperture diameters of the spherical lens 39. In FIG. 6, the divergence angle yθ in the case where the aperture diameter is shorter, which corresponds to the transverse direction of the rectangular shape, is smaller than the divergence angle xθ in the case where the aperture diameter is longer, which corresponds to the longitudinal direction of the rectangular shape. As illustrated in FIG. 6, the smaller the aperture is, the smaller the divergence angle becomes because the refractive power of the curved surface of the spherical lens 39 is smaller. In other words, the advantage effects of the present embodiment work by setting the vertical and horizontal length of the microlens (i.e., the spherical lens 39) so as to match the rectangular shape having predetermined divergence angles. In the present embodiment, the curvature of the lens has a rotational symmetry, but is not limited thereto. The lens may have a free-form surface, and the divergence angles may depend on surface directions.

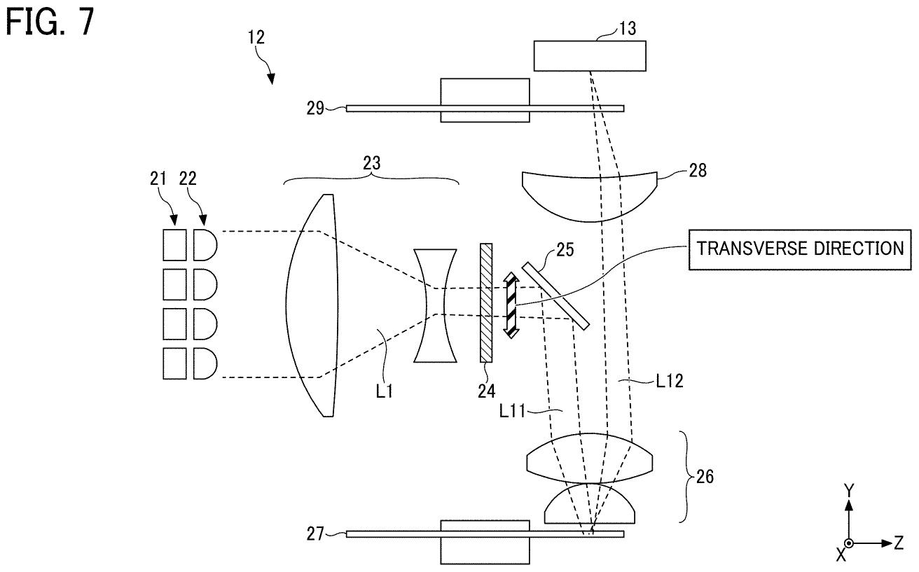

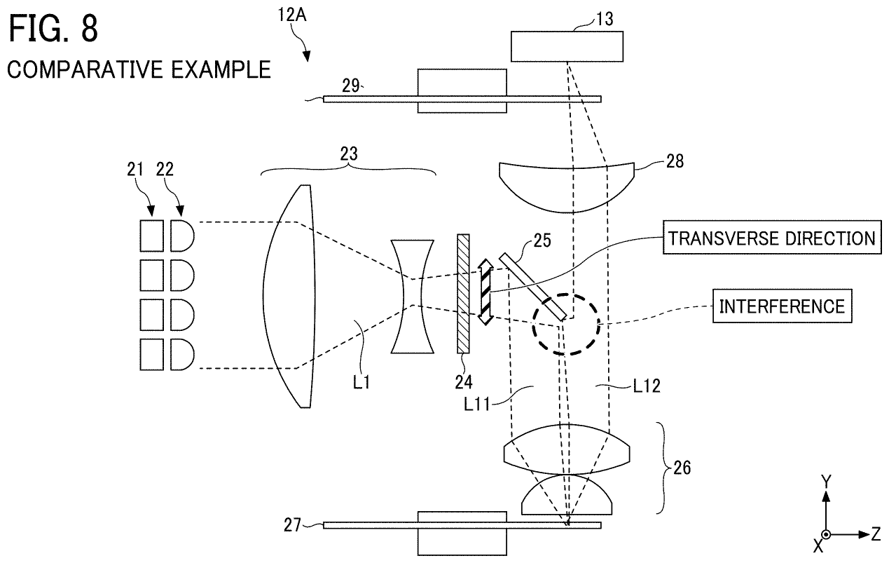

FIG. 7 is a diagram of an optical path of the excitation light L1 in the light source device 12 according to the first embodiment. FIG. 8 is a diagram of an optical path of the excitation light L1 in a light source device 12A according to a comparative example. As illustrated in FIG. 8, in the light source device 12A of the comparative example, the longitudinal direction of the spherical lens 39 (having the rectangular outer shape) of the optical element 24 is parallel to the YZ-plane. By contrast, as illustrated in FIG. 7, in the light source device 12 according to the present embodiment, the transverse direction of each spherical lens 39 of the optical element 24 is parallel to the YZ-plane as described above.

In FIGS. 7 and 8, the width of the light beam of the excitation light L1 is represented by a broken line in both cases. As illustrated in FIG. 7, in the light source device 12 according to the present embodiment, the dichroic mirror 25 deflects the excitation light L11 by 90 degrees in its optical path, the excitation light L11 is reflected by the phosphor wheel 27 to generate the reflected light L12, and the reflected light L12 is guided to the light homogenizer 13 without hitting the dichroic mirror 25.

By contrast, as illustrated in FIG. 8, in the light source device 12A according to the comparative example, as described above with reference to FIG. 6, since the divergence angle of the excitation light L1 in the optical element 24 is larger than that of the excitation light L1 in the optical element 24 in FIG. 7, the excitation light L11 overflows from the reflection surface of the dichroic mirror 25. Alternatively, since the excitation light L12 reflected by the phosphor wheel 27 interferes with the dichroic mirror 25 (interference with the dichroic mirror), the efficiency is reduced. If the amount of the off-axis of the first optical system 23 and the second optical system 26 are increased in order to avoid the interference with the dichroic mirror, the light spot on the phosphor wheel 27 becomes a trapezoidal shape, so that the light is cut by the light homogenizer 13, the illumination optical systems 14, and the projection optical system 16 after passing through the light homogenizer 13. Accordingly, the efficiency is decreased.

In FIG. 2, when the excitation light L1 strikes a portion in which the phosphor 37 is formed on the phosphor wheel 27 (i.e., the phosphor region 32), the excitation light L1 is converted into the fluorescent light L2 (i.e., the second color light) in wavelength. The second color light is yellow light, green light, or red light. In FIG. 2, the second color light (i.e., wavelength converted light) is represented as the gray arrow. The second color light becomes the substantially parallel light by the second optical system 26, and passes through a portion of the dichroic mirror 25, the condenser lens 28, and the color wheel 29, and enters the light homogenizer 13.

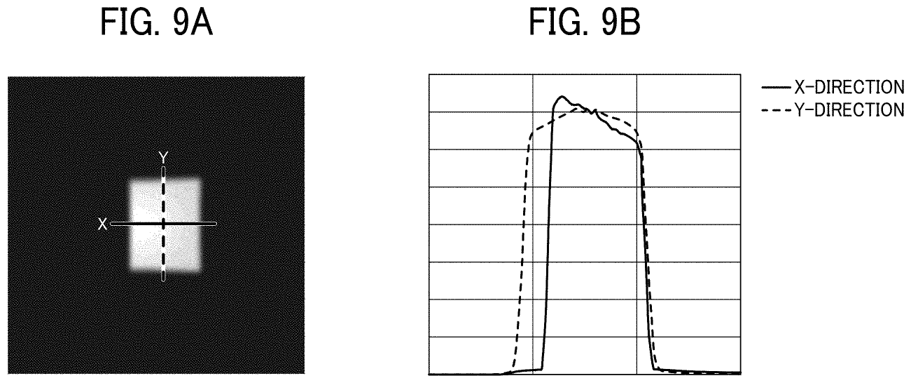

FIG. 9A is a diagram of an image formed on the phosphor wheel, and FIG. 9B is a graph of the luminance (intensity) distribution of the image according to the first embodiment. FIG. 9A is a diagram of an image formed on the phosphor region 32 of the phosphor wheel 27, and FIG. 9B is a graph of the luminance (intensity) distributions of the image in the X-direction and the Y-direction (the cross-sectional image of the image in FIG. 9A). In FIG. 9B, the luminance in the X-direction is represented by a solid line, and the luminance in the Y-direction is represented by a dashed line. As illustrated in FIG. 9B, since the luminance distribution is close to a top hat shape in both the X-direction and the Y-direction, the whole image is uniform.

As a result, a local temperature rise of the phosphor 37 is prevented, and the luminous efficiency of the phosphor 37 is increased Further, since the aspect ratio of the image in the X-direction and the Y-direction are closer to the aspect ratios of the entrance shape of the light homogenizer 13 and the image forming surface of the image formation element 15, the light is less likely to cut by the illumination optical system 14 and the projection optical system 16 in the following optical path. Accordingly, the efficiency is increased.

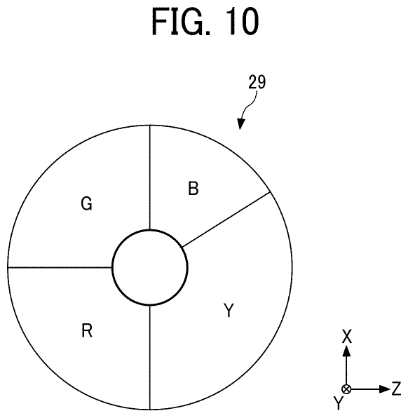

FIG. 10 is a diagram of a configuration of a color wheel 29 according to the first embodiment. As illustrated in FIG. 10, the color wheel 29 is divided into four regions of a blue region B, a yellow region Y, a red region R, and a green region G. The blue region B corresponds to the excitation light reflection region 33 of the phosphor wheel 27 in FIG. 3, and the yellow region Y, the red region R, and the green region G are synchronized so as to respectively correspond to the phosphor regions 32 of the phosphor wheel 27 in FIG. 3. The coherence of the laser light source 21 is reduced by arranging a transmission diffuser in the blue region B, and the speckle on the screen SC is decreased. The yellow region Y transmits the wavelength band of the yellow fluorescent light L2 emitted from the phosphor 37 as it is. Further, the red region R and the green region G respectively reflect the light in an unusable wavelength range from the wavelength of the yellow fluorescent light L2 by using a dichroic mirror to obtain higher-purity color light. The light of each color produced by the color wheel 29 in the time-division manner is guided to the image formation element 15 through the illumination optical system 14 and forms an image corresponding to each color. The image corresponding to each color is magnified and projected on to the screen SC by the projection optical system 16. As a result, a color image is formed.

### Second Embodiment

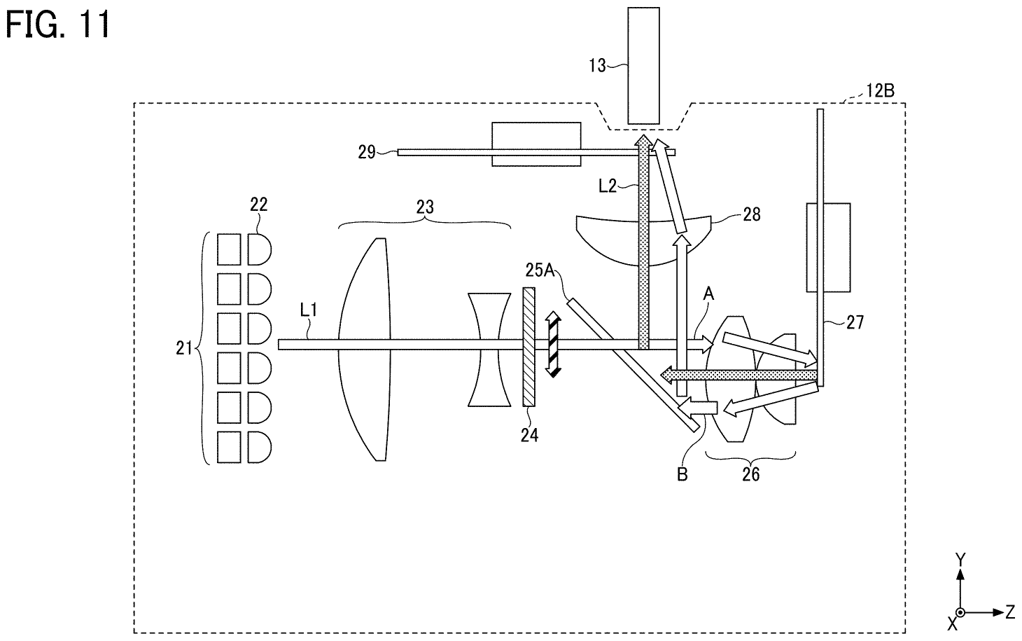

FIG. 11 is a diagram of a light source device 12B according to the second embodiment.

As illustrated in FIG. 11, in the light source device 12B according to the second embodiment, the second optical system 26 and the phosphor wheel 27 are arranged in the arrangement direction (i.e., Z-direction) of the laser light source 21 or the collimator lens 22.

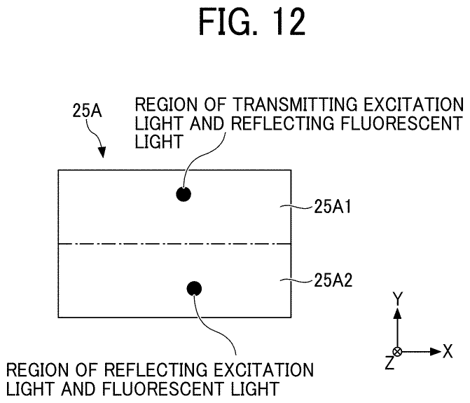

A first portion of the dichroic mirror 25A transmits the excitation light L1 and the reflects the fluorescent light L2, and a second portion different from the first portion of the dichroic mirror 25A reflects the excitation light L1 and the fluorescent light L2. The area ratio of the first portion and the second portion is about fifty-fifty. In FIG. 12, the first portion is arranged at an upper portion and the second portion is arranged at a lower portion of the dichroic mirror 25A along the Y-direction.

FIG. 12 is a plan view of a dichroic mirror 25A as viewed from the light incident direction (i.e., the negative Z-direction). Specifically, as illustrated in FIG. 12, the first portion 25A1 is referred to as the region of reflecting the excitation light L1 and fluorescent light L2, and the second portion 25A2 is referred to as the region of transmitting the excitation light L1 and reflecting fluorescent light L2. As described above, the area ratio of the first portion 25A1 and the second portion 25A2 is about fifty-fifty. In FIG. 12 the first portion 25A1 is a +Y-directional portion of the dichroic mirror 25A, and the second portion 25A2 is a −Y-directional portion of the dichroic mirror 25A.

Effect

As illustrated in FIG. 2 and FIG. 11, the light source devices 12 and 12B of the display apparatus 11 according to the embodiments described above includes a laser light source 21 that emits light including excitation light L1 (i.e., first color light), an optical element 24 in which multiple spherical lenses 39 are arranged on at least one surface in order from the side of the laser light source 21, a second optical system 26 (i.e., condenser optical system), a phosphor wheel 27 (i.e., wavelength converter), and dichroic mirrors 25 and 25A (color separation element) that separate the first color light (i.e., the excitation light L1) and the second color light (i.e., the fluorescent light L2) converted by the phosphor wheel 27 in wavelength. When a plane (i.e., the YZ-plane) formed by incident light and reflected light of a first color light (i.e., the excitation light L1) incident on dichroic mirrors 25 and 25A is defined, an optical element 24 is an element having different divergence angles yθ and xθ in the Y-direction (i.e., the first direction) along the YZ-plane and in the X-direction (i.e., the second direction) perpendicular to the YZ-plane, and the divergence angle yθ in the first direction is smaller than the divergence angle xθ in the second direction.

According to the configuration, as illustrated in FIG. 7, in a plane (YZ plane) formed by the incident light and the reflected light of the first color light (the excitation light L1) incident on the dichroic mirrors 25 and 25A, the divergence angle yθ of the excitation light L1 after passing through the optical element 24 incident on the dichroic mirrors 25 and 25A becomes relatively smaller, so that the width of the light beam of the incident light becomes relatively smaller so as to fit within the range of the dichroic mirrors 25 and 25A. Thus, the excitation light L1 is less likely to decrease in the reflection or transmission of the dichroic mirrors 25 and 25A. Thus, the width of the light beam of the reflected light L1i from the dichroic mirrors 25 and 25A is reduced. As a result, the width of the light beam of the excitation light L12 after being reflected by the phosphor wheel 27 becomes smaller, and the interference of the excitation light L12 with the dichroic mirror 25 is prevented, and efficiency is less likely to decrease. Thus, in the light source devices 12 and 12B of the display apparatus 11 according to the embodiments described above, the luminous efficiency of the excitation light L1 and the fluorescence light L2 enter the light homogenizer 13 is increased, and higher efficiency is achieved. Further, since the efficiency is increased, the number of excitation light sources used for the light source devices 12 and 12B is reduced, heat generation is decreased, and power consumption is reduced, and power supply and cooling device is reduced in size, which leads to reduction in size of the light source devices 12 and 12B. Thus, the size of the entire the display apparatus 11 is reduced. According to the embodiments of the present invention, in the projection display apparatus, the light source device increases the efficiency, and the size of the light source device is reduced.

A display apparatus includes: the light source device according to the embodiments; a light homogenizer to homogenize light emitted from the light source device; an illumination optical system to illuminate an image formation element with the light homogenized by the light homogenizer to generate an image; and a projection optical system to magnify and project the image formed by the image formation element outside the display apparatus.

Further, in the light source devices 12 and 12B of the display apparatus 11 according to the present embodiment, the first color light (i.e., the excitation light L1) enters the phosphor wheel 27, and a portion of the first light is converted into the second color light (i.e., the fluorescent light L2) having the longer wavelength than the wavelength of the excitation light L1. The principal ray A and the principal ray A1 of the incident light of the excitation light L1 incident on the phosphor wheel 27 and the principal ray B and the principal ray B1 of the reflected light of the excitation light L1 reflected by the phosphor wheel 27 do not coincide with each other. The fluorescent light L2 becomes substantially parallel light by the second optical system 26, and the principal ray (i.e., the gray arrow in FIG. 2) of the fluorescent light L2 does not coincide with the principal rays A and A1 of the incident light of the excitation light L1 and the principal rays B and B1 of the reflected light.

In the light source device according to the embodiments, the wavelength converter: converts the first color light incident on the wavelength converter into the second color light, and reflects the first color light and emits third color light including a third principal ray. The first color light includes a first principal ray having a first wavelength, and the second color light includes a second principal ray having a second wavelength longer than the first wavelength. The first principal ray passes through a first optical path, and the third principal ray passes through a third optical path different from the first optical path. The condenser optical system collimates the second color light to substantially parallel light, and the second principal ray of the second color light passes through a second optical path different from the first optical path and the third optical path.

According to the present configuration, as illustrated in FIG. 2 and FIG. 11, the optical paths of the second color light (i.e., the fluorescent light L2) and the first color light (i.e., the excitation light L1) are overlapped, so that the size of the optical system of the light source devices 12 and 12B is reduced.

In the light source device, the wavelength converter: converts the first color light including a first principal ray incident on the wavelength converter into the second color light including a second principal ray having a wavelength longer than a wavelength of the first principal ray, or reflects the first color light including the first principal ray incident on the wavelength converter and emits third color light including a third principal ray, the first principal ray passes through an optical path different from an optical path through which the third principal ray passes, the second color light is collimated by the condenser optical system to be substantially parallel light, and the second principal ray of the second color light passes through an optical path different from the optical path through which the first principal ray passes and the optical path through which the third principal ray passes.

Further, in the light source devices 12 and 12B of the display apparatus 11 according to the present embodiment, the phosphor wheel 27 has at least two regions, one region (i.e., the phosphor region 32) of the two region is coated with the wavelength conversion layer (i.e., the phosphor 37), and the other region (i.e., the excitation light reflection region 33) of the two region reflects the first color light (i.e., the excitation light L1).

In the light source device according to the embodiments, the wavelength converter includes: a first region including a wavelength conversion layer to convert the first color light into the second color light; and a second region configured to reflect the first color light.

According to the configuration, when excitation light L1 strikes the phosphor region 32, the excitation light L1 is converted into the fluorescent light L2 in wavelength and reflected, and when the excitation light strikes the excitation light reflection region 33, the excitation light L1 is reflected as it is. In other words, the excitation light L1 and the fluorescent light L2 are emitted to the light homogenizer 13 by a single phosphor wheel 27. Thus, the size of the optical system of light source devices 12 and 12B is reduced. In a case where multiple phosphor wheels 27 are used, the range of color reproducibility is further expanded, and the display apparatus 11 can express more richly colored images.

In the light source device, the wavelength converter includes at least two regions, one region of the two regions includes a wavelength conversion layer, and another region of the two regions reflects the first color light.

Further, in the light source devices 12 and 12B of the display apparatus 11 according to the present embodiment, in the multiple spherical lenses 39 of the optical element 24 the lens interval Py in the Y-direction (i.e., the first direction) and the lens interval Px in the X-direction (i.e., the second direction) are different from each other. The lens interval Py (i.e., the first direction) is smaller than the lens interval Px (i.e., the second direction).

In the light source device according to the embodiments, the multiple lenses of the optical element has: a first lens interval between adjacent two lenses of the multiple lenses in the first direction; and a second lens interval between adjacent two lenses of the multiple lenses in the second direction, and the first lens interval is smaller than the second lens interval.

According to the configuration, the function that “the divergence angle yθ of the optical element 24 in the first direction is smaller than the divergence angle xθ in the second direction” described above is achieved with a simpler configuration.

In the light source device, the multiple lenses of the optical element has a lens interval between adjacent two lenses in the multiple lenses, the lens interval of the first direction and the lens interval of the second direction are different from each other, the lens interval of the first direction is smaller than the lens interval of the second direction.

Specifically, in the light source devices 12 and 12B of the display apparatus 11 according to the present embodiment, the dichroic mirrors 25 and 25A have the reflection surface between the optical element 24 and the second optical system 26, and either the first color light (i.e., the excitation light L1) incident on the phosphor wheel 27 or the first color light reflected by the phosphor wheel 27 strikes the reflection surface. More specifically, in the light source device 12 according to the first embodiment in FIG. 2, only the first color light incident on the phosphor wheel 27 strikes the reflection surface of the dichroic mirror 25, and the first color light reflected by the phosphor wheel 27 enters the condenser lens 28 without striking the reflection surface of the dichroic mirror 25. By contrast, in the light source device 12B according to the second embodiment in FIG. 11, only the first color light reflected by the phosphor wheel 27 strikes the reflection surface (i.e., the second portion 25A2, the region of reflecting the excitation light L1 and the fluorescence light L2) of the dichroic mirror 25A, and the first color light (i.e., the excitation light L1) strikes the first portion 25A1 (i.e., the region of transmitting the excitation light L1 and reflecting the fluorescent light) of phosphor wheel 27 without striking the reflection surface.

In the light source device according to the embodiments, the color light separator includes a reflection surface between the optical element and the condenser optical system, the reflection surface of the color light separator reflects the first color light incident from the optical element to the wavelength converter, and the first color light reflected from the wavelength converter enters the condenser optical system without striking the reflection surface of the color light separator.

In the light source device according to the embodiments, the color light separator includes: a first region to: transmit the first color light incident from the optical element to the wavelength converter; reflect the second color light converted by the wavelength converter; and a second region to reflect the second color light converted by the wavelength converter and the first color light reflected by the wavelength converter.

According to the configuration, since the divergence angle of the first color light (i.e., the excitation light L1) after passing through the optical element 24 is decreased, the efficiency of the display apparatus 11 (projection display apparatus) is increased and the size of the projection display apparatus is reduced. Further, by appropriately selecting the dichroic mirrors 25 and 25A, the light source devices 12 and 12B can have a preferable layout, and the versatility is increased.

The present embodiments are described with reference to specific examples. However, the present disclosure is not limited to these embodiments. Those in which a person skilled in the art makes appropriate design changes to these specific examples are also included in the scope of the present disclosure as long as they have the features of the present disclosure. The elements, arrangement, condition, shape, and the like of each of the above-described specific examples are not limited to those illustrated, and may be changed as appropriate. As long as there is no technical contradiction, the combination of elements provided in each of the above-described specific examples can be appropriately changed.

Aspects of the present invention are as follows, for example.

In a first aspect, a light source device includes: a light source to emit light including first color light of excitation light; an optical element including multiple lenses on at least one surface of the optical element; a condenser optical system to condense the first color light; a wavelength converter to convert the first color light into second color light; and a color light separator to separate the first color light and the second color light. The light source, the optical element, the condenser optical system, the wavelength converter, and the color light separator are disposed in this order from the light source. The multiple lenses of the optical element has: a first divergence angle in a first direction along a plane of the multiple lenses; and a second divergence angle in a second direction orthogonal to the first direction along the plane, and the first divergence angle is smaller than a second divergence angle.

In a second aspect, in the light source device according to the first aspect, the wavelength converter: converts the first color light incident on the wavelength converter into the second color light, and reflects the first color light and emits third color light including a third principal ray. The first color light includes a first principal ray having a first wavelength, and the second color light includes a second principal ray having a second wavelength longer than the first wavelength. The first principal ray passes through a first optical path, and the third principal ray passes through a third optical path different from the first optical path. The condenser optical system collimates the second color light to substantially parallel light, and the second principal ray of the second color light passes through a second optical path different from the first optical path and the third optical path.

In a third aspect, in the light source device according to the first aspect or the second aspect, the wavelength converter includes: a first region including a wavelength conversion layer to convert the first color light into the second color light; and a second region configured to reflect the first color light.

In a fourth aspect, in the light source device according to any one of the first aspect to the third aspect, the multiple lenses of the optical element has: a first lens interval between adjacent two lenses of the multiple lenses in the first direction; and a second lens interval between adjacent two lenses of the multiple lenses in the second direction, and the first lens interval is smaller than the second lens interval.

In a fifth aspect, in the light source device according to any one of the first aspect to the fourth aspect, the color light separator includes a reflection surface between the optical element and the condenser optical system, the reflection surface of the color light separator reflects the first color light incident from the optical element to the wavelength converter, and the first color light reflected from the wavelength converter enters the condenser optical system without striking the reflection surface of the color light separator.

In a sixth aspect, in the light source device according to the fifth aspect, the color light separator includes: a first region to: transmit the first color light incident from the optical element to the wavelength converter; and reflect the second color light converted by the wavelength converter; and a second region to reflect the second color light converted by the wavelength converter and the first color light reflected by the wavelength converter.

In a seventh aspect, a display apparatus includes: the light source device according to any one of the first aspect to the sixth aspect; a light homogenizer to homogenize light emitted from the light source device; an illumination optical system to illuminate an image formation element with the light homogenized by the light homogenizer to generate an image; and a projection optical system to magnify and project the image formed by the image formation element outside the display apparatus.

In an eighth aspect, in the light source device according to the second aspect, a longitudinal direction of the multiple lenses of the optical element is orthogonal to a plane parallel to the first principal ray and the second principal ray.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A light source device comprising:
a light source configured to emit light including first color light of excitation light;
an optical element including multiple lenses on at least one surface of the optical element;
a condenser optical system configured to condense the first color light;
a wavelength converter configured to convert the first color light into second color light, and
a color light separator configured to separate the first color light and the second color light,
the light source, the optical element, the condenser optical system, the wavelength converter, and the color light separator are disposed in this order from the light source,
wherein the multiple lenses of the optical element has:
a first divergence angle in a first direction along a plane of the multiple lenses, and
a second divergence angle in a second direction orthogonal to the first direction along the plane, and
the first divergence angle is smaller than a second divergence angle.

2. The light source device according to claim 1,
wherein the wavelength converter:
converts the first color light incident on the wavelength converter into the second color light, the first color light including a first principal ray having a first wavelength, and the second color light including a second principal ray having a second wavelength longer than the first wavelength; and
reflects the first color light and emits third color light including a third principal ray,
the first principal ray passes through a first optical path; and
the third principal ray passes through a third optical path different from the first optical path,
the condenser optical system collimates the second color light to substantially parallel light, and
the second principal ray of the second color light passes through a second optical path different from the first optical path and the third optical path.

3. The light source device according to claim 1,
wherein the wavelength converter includes:
a first region including a wavelength conversion layer configured to convert the first color light into the second color light; and
a second region configured to reflect the first color light.

4. The light source device according to claim 1,
wherein the multiple lenses of the optical element has:
a first lens interval between adjacent two lenses of the multiple lenses in the first direction, and
a second lens interval between adjacent two lenses of the multiple lenses in the second direction, and
the first lens interval is smaller than the second lens interval.

5. The light source device according to claim 1,
wherein the color light separator includes a reflection surface between the optical element and the condenser optical system,
the reflection surface of the color light separator reflects the first color light incident from the optical element to the wavelength converter, and
the first color light reflected from the wavelength converter enters the condenser optical system without striking the reflection surface of the color light separator.

6. The light source device according to claim 1,
wherein the color light separator includes:
a first region configured to:
transmit the first color light incident from the optical element to the wavelength converter; and
reflect the second color light converted by the wavelength converter; and
a second region configured to reflect the second color light converted by the wavelength converter and the first color light reflected by the wavelength converter.

7. A display apparatus comprising:
the light source device according to claim 1;
a light homogenizer configured to homogenize light emitted from the light source device;
an illumination optical system configured to illuminate an image formation element with the light homogenized by the light homogenizer to generate an image; and
a projection optical system configured to magnify and project the image formed by the image formation element outside the display apparatus.

8. The light source device according to claim 2,
wherein a longitudinal direction of the multiple lenses of the optical element is orthogonal to a plane parallel to the first principal ray and the second principal ray.
